(19) United States
(12) Patent Application Publication
(10) Pub. No.: US 2006/0150705 A1
(43) Pub. Date: Jul. 13, 2006

(54) Hong ring pliers with automatic feed apparatus

(76) Inventor: Dara Cheng, San Diego, CA (US)

Correspondence Address: ERIC HANSCOM, 7395 PORTAGE WAY, CARLSBAD, CA, 92011, US

(21) Appl. No.: 10/870,798

(22) Filed: Jun. 18, 2004

(51) Int. Cl. B25C 5/00

(52) U.S. Cl. 72/409.03

(57) ABSTRACT

The present invention is directed to a hog ring pliers with automatic feed mechanism which provides an efficient method of attaching hog rings and similar devices. A brittle plastic strip to which are adhered a plurality of hog rings of a predetermined spacing is inserted into the loading sleeve of the invention and each hog ring is advanced into the jaws of the invention automatically upon the closure of the preceding hog ring and the trimming of the brittle plastic strip behind it.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF INVENTION

The hog ring has been a popular method of quickly, effectively, and inexpensively attaching two or more objects together for many centuries. The hog ring is an overlapping circle which runs through holes in the objects being attached, thereby securing the objects together. Hog rings are generally made of a single piece of straight, round metal, and are malleable enough to be bent, but strong enough to hold its shape. The hog ring is sold in a partially bent position, in which it has been bent into a rough “C” shape. Its function is relatively simple: in its open position the hog ring is a “C-shaped” piece of metal with an opening of approximately 90 degrees between its two ends. In its closed position, the two ends are compressed toward each other until the ends overlap each other, effectively closing the opening and attaching anything that was placed between the two ends prior to their being compressed. Some of the more common uses of hog rings are to attach chain link fence to structural members and support wires. It is also commonly used in agricultural communities to attach wire to fences, and to attach tarps to guide wires.

While the hog ring is a popular device, the means of compressing them has remained relatively primitive. To date, the most frequently used means of compressing the “open” hog ring into a closed circle is a manual bending device, usually gripped in one hand, generally made of two mated pieces of metal, both with handle sections and jaw sections. Each piece of metal is curved such that when the two pieces of joined at a pivot point located about two-thirds of the way from the handle section to the jaw section the jaws can be brought together by pulling the two handle sections toward one another by a user pulling his/her fingers toward his/her palm.

After compressing one hog ring, the user then manually opens the jaws of the device, inserts another hog ring, and compresses. The inconvenience of having to manually insert each hog ring, the time lost of repeating this maneuver up to hundreds of time each day for a heavy user of hog rings, along with the increased likelihood that a user will drop or lose a hog ring trying to retrieve it from its storage location and manually insert it into the jaws of the device are all reasons why there has been a long-felt need for a device which automatically feed hog rings into the jaw portion and allows a user to quickly and efficiently attach the hog rings to the desired object.

There have been attempts to design a set of hog ring pliers which could accommodate multiple hog rings. For example, U.S. Pat. No. 5,983,697 to West illustrates the traditional approach by which one or more hog rings are inserted into a chamber whereupon the jaws of the hog ring pliers. This invention, however, does not supply the hog rings in a longitudinal, stick fashion, nor does it provide for a comfortable, pistol-like grip as does the present invention.

### BRIEF SUMMARY OF INVENTION

It is therefore an object of this invention to provide a quick and efficient method of attaching hog rings without the necessity of continually having to place each individual hog ring in the jaws of the hog ring pliers before compressing the hog ring.

It is a further object of this invention that a strip of hog rings can be manufactured in which the hog rings are attached by glue or a similar substance to a brittle strip of plastic which carries each hog ring into the jaws of the hog ring pliers, and then is easily snapped off when the pliers close on the hog ring.

Other and further objects and features of this invention will be apparent to one skilled in the art.

### BRIEF DESCRIPTION OF THE SEVERAL VIEWS OF THE DRAWINGS

FIG. 1 is side view of the invention.

FIG. 2 is a side view, partially cut away, showing the inner workings of the invention.

FIG. 3 is a side view of the hog ring stick assembly, showing how the hog rings are glued or otherwise attached in sequence along a piece of brittle plastic.

### DETAILED DESCRIPTION OF THE INVENTION

The present invention is directed to hog ring pliers which can use hog rings fed into it by either a manual method or by an automatic method involving a strip of brittle plastic upon which have been glued or otherwise attached a series of spaced hog rings.

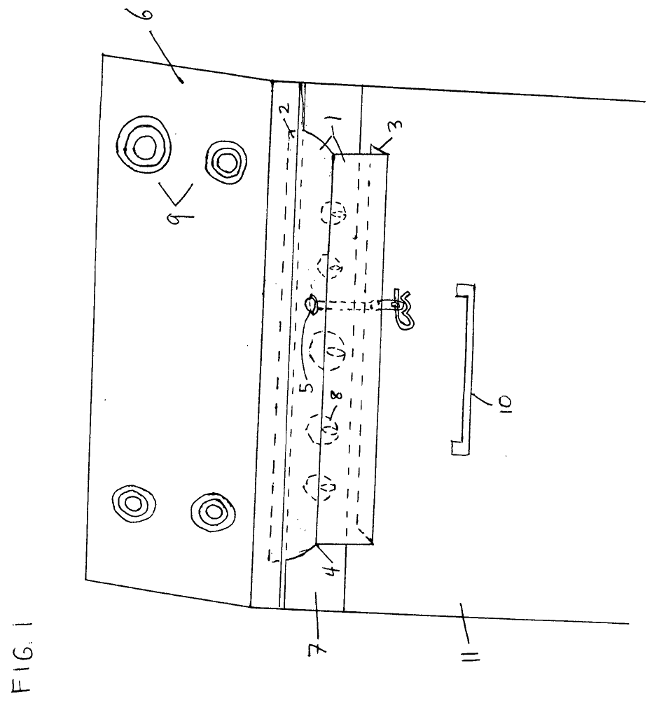

Referring to the drawings, and particularly to FIG. 1, the invention consists of a palm handle (1) which fits against the palm of a hand. The palm handle (1) is comprised of two halves (not shown in this picture), attached to each other a plurality of attachment devices (2) such as screws or rivets. There is a finger handle (3) that is located in between the two halves of the palm handle (1), and pivots around a finger handle attachment point (10). Also attached to the finger handle attachment point (10) is a control rod (9) which controls an upper jaw (7). The upper jaw (7), when pulled down by the control rod (9), due to pressure from a user's fingers on the finger handle (3), will compress a hog ring (not shown in this figure) against the lower jaw (8). The hog rings, when the invention is used in automatic mode, are stored in a loading sleeve (12) which is most obscured in this drawing by the loading sleeve cover (4). A loading sleeve lock (6) keeps the loading sleeve (4) in position over the hog rings (not shown), until all the hog rings are used up. At that time, the loading sleeve lock (6) can be pulled down by the user, and the loading sleeve cover (4) can be pulled back, in the direction indicated by reference number 5, so that more hog rings can be placed in the loading sleeve (12).

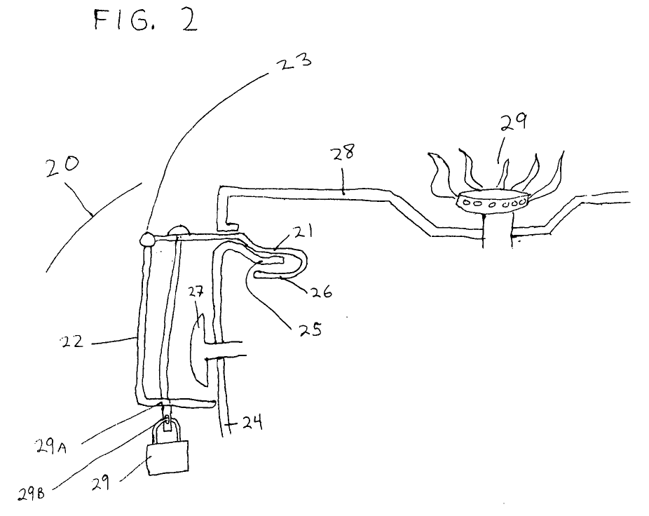

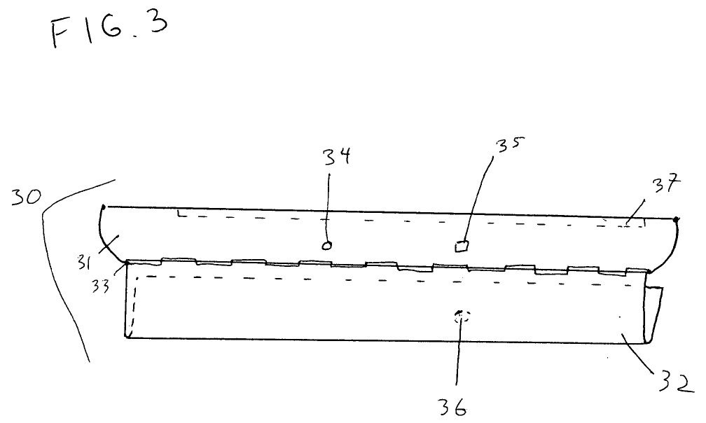

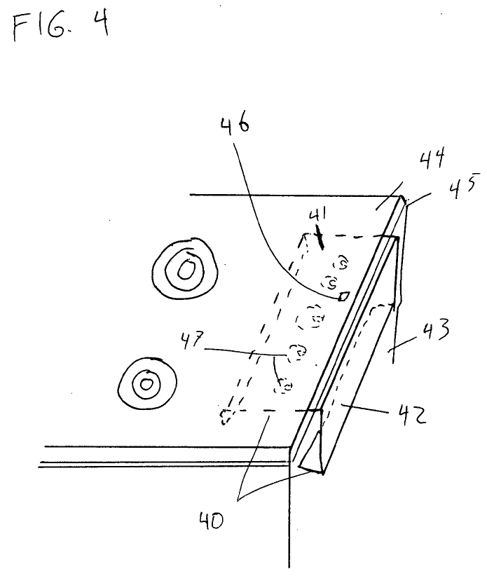

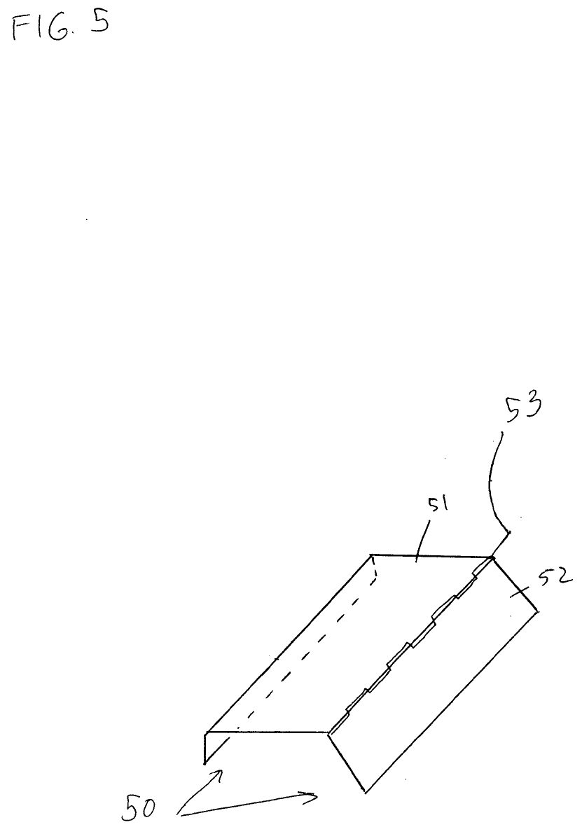

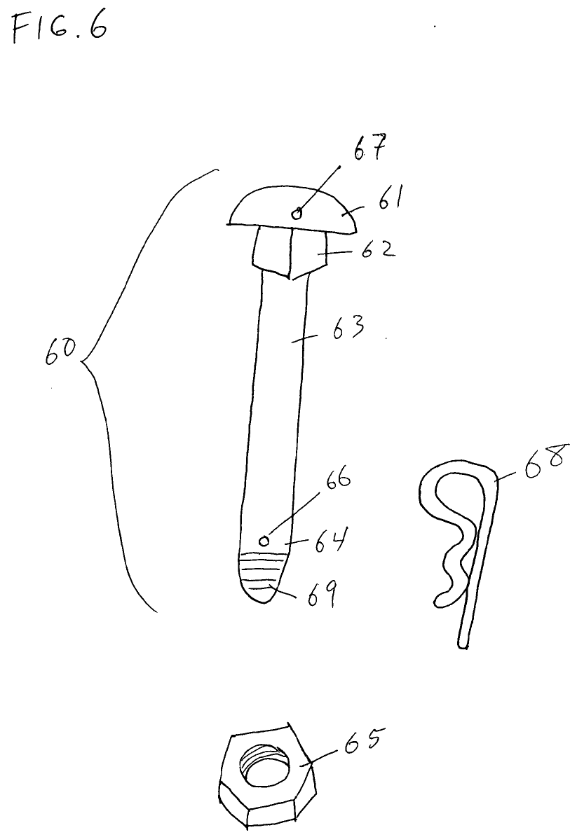

FIG. 2 is another side view of the invention, with the loading sleeve cover cut away to expose the inner workings of the hog ring pliers. A palm handle (31) and a finger handle (32) are gripped by the user, with a plurality of finger grips (33) on the finger handle (32) for comfortable and effective gripping by the user. The finger handle (32) is fixed in between the two halves (not shown) of the palm handle (31) at a finger handle pivot point (48), which consists of a an attachment device such as a screw or rivet which makes a “sandwich” of the finger handle (32) in between the two halves (not shown) of the palm handle (31). As the finger handle (32) is pulled back by the user, it compresses a finger handle return spring (46) which returns the finger handle (32) to its original position once pressure is released. As the finger handle (32) is pulled back by a user, a control rod (39) is also pulled back. The control rod (39) is attached to the finger handle (32) at a control rod pinion point (40), which consists of an attachment device such as a screw, bolt, or rivet, which attaches the control rod (39) to the finger handle (32) but allows the control rod (39) to rotate about the control rod pinion point (40) as the finger handle (32) is pulled back. As the control rod (39) is pulled back, the distal end of the control rod (39), a control rod T-bar (38), which is attached to an upper jaw (35), pulls the upper jaw (35) down upon a hog ring (44) which is situated between the upper jaw (35) and a lower jaw (36). After the hog ring (44) has been crimped from an open position (shown here) to a closed position (not shown here), an upper jaw return spring (37) returns the upper jaw to an “open position”, in which the opening between the upper jaw (35) and the lower jaw (36) can accommodate a hog ring (44) in its “open” position. The hog ring (44) can be inserted manually, one at a time (not shown here), or as part of a hog ring magazine, shown here consisting of a plurality of hog rings (43) held to a brittle plastic strip (47) by glue or some other attachment means. The plastic strip fits into a track in the loading sleeve slot (not shown here) within a loading sleeve (45) which keep the magazine in alignment such that each hog ring (44) enters the space between the upper jaw (35) and the lower jaw (36) in the suitable alignment. The hog rings (43) are spaced on the brittle plastic strip (47) such that after each hog ring (44) in between the upper jaw (35) and the lower jaw (36) is closed, the section of the brittle plastic strip (47) between the hog ring just close and the next one on the brittle plastic strip (47) breaks off, thereby allowing the next hog ring to enter the jaws of the invention. Pushing the brittle plastic strip (47) toward the jaws of the invention is a loading sleeve spring (42), which pushes a loading sleeve pushing block (41) against the brittle plastic strip (47), moving the brittle plastic strip (47) toward the jaws of the invention. The loading sleeve cover (not shown here) can be removed to replace magazines of hog rings by pulling in a downward direction (48) on a loading sleeve lock (34) which is a flat piece of metal, plastic or a similar material which is attached to and pivots around a lock attachment point (49) which is a screw, bolt, rivet or other means of attachment. As the upper jaw (35) closes on the hog ring (44), an upper jaw plastic cutter (47A) trims the brittle plastic strip (47) behind the hog ring (44), thereby allowing the next hog ring to slide into the jaws of the invention.

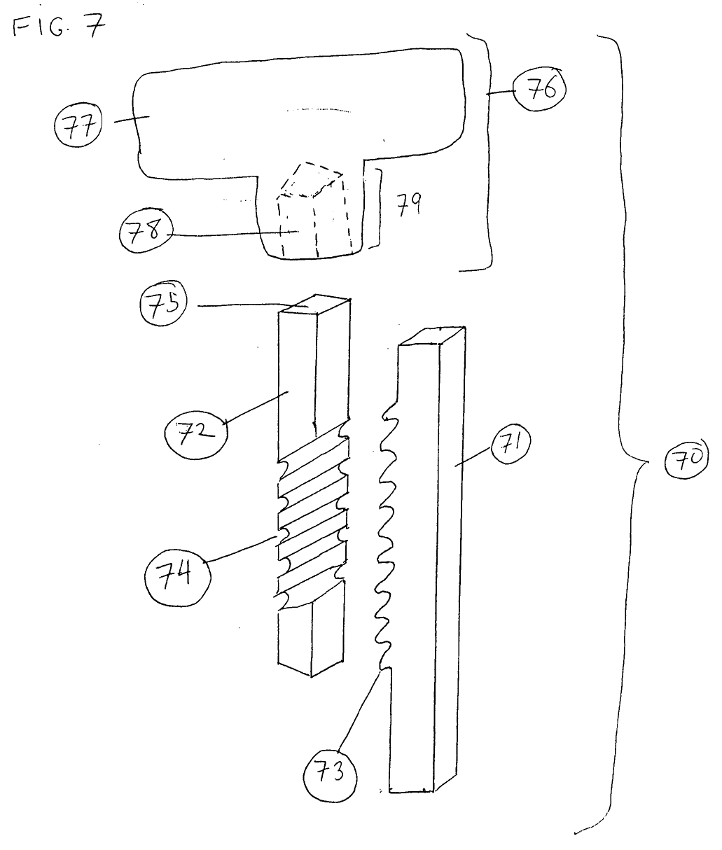

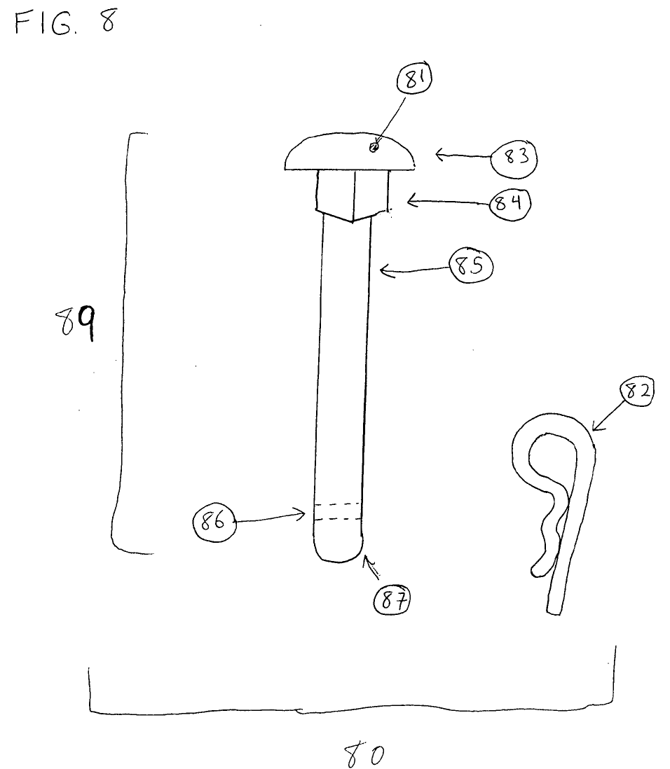

FIG. 3 is a side view of the hog ring magazine, that fits into the loading sleeve and forwards hog rings one at a time into the jaws of the hog ring pliers. Here, the device, generally referred to by reference number 50, comprises a brittle plastic strip (53) onto which a series of hog rings (51) are attached by glue, placing hot hog rings onto the plastic where they will partially melt the plastic and stick to it, or other means. The hog rings (51) are spaced at a distance (52) which allows each hog ring to be effectively crimped by the jaws of the invention before the next hog ring enters the jaws.

What I claim is:

1. A device for manually closing hog rings, comprising:
a palm handle in the shape of a pistol grip that is located at the user end of the device, and another finger handle shaped liked a pistol grip that is located toward the object end of the device, the palm handle and the finger handle being connected such that a user can squeeze the palm handle and the finger handle toward each other by pulling his/her fingers back toward his/her palm, thereby compressing the connecting ends of a hog ring from an open position to a closed position such that the hog ring can be closed to attach two or more materials together,
a removable and replaceable upper jaw designed and manufactured to accommodate different sizes of hog rings,
a reloadable sleeve that can be locked into place and is tensioned with a spring,
a sleeve return spring that provides force against the hog ring in the reloadable sleeve such that the hog ring is pushed into a position between the upper jaw and lower jaw for compression from the open position to the closed position.
an upper jaw return spring which works to release the hog ring into place after it has been compressed from its open position to closed position,
a lower jaw,
a locking mechanism located in the lower jaw which holds and cuts
a handle return spring which works to release the hog ring into place after it has been compressed from its open position to closed position,

2. The device of claim 1, where, the reloadable sleeve can accommodate a magazine of hog rings which are removably adhered to a brittle, plastic strip such that the magazine holds each hog ring in a vertical, pre-spaced position such that after attaching the previous hog ring, the sleeve automatically moves forward the magazine such that the next hog ring moves into place between the jaws, thereby making the next hog ring ready for attachment by the sole action of the user squeezing together his/her hand, and as each hog ring is closed an upper jaw plastic cutter trims the brittle plastic strip behind the closed hog ring thereby allowing the next hog ring to slide into the space between the upper and lower jaws.

3. The device of claim 2, where, the reloadable sleeve has an upper member which can be readily removed by a user when a magazine of hog rings is spent and the user wishes to replace to used magazine with a new magazine.

4. The device of claim 3, where, the reloadable sleeve can be locked into place with a lock pin, and the lock pin is tensioned with a spring such that the lock pin will not release the reloadable sleeve without a user's action to remove the tension on the lock pin.

5. The device of claim 4, where, a sleeve return spring that provides force against the hog ring magazine in the reloadable sleeve such that the hog ring is pushed into a position between the upper jaw and lower jaw for compression from the open position to the closed position.

6. The device of claim 5, where, a locking mechanism located in the lower jaw which holds and cuts the hog ring from the magazine after it has been compressed.

7. The device of claim 5, where, the upper jaw and lower jaw can be removed and replaced with upper and lower jaws for attaching other objects other than hog rings.
